(19) United States
(12) Patent Application Publication
(10) Pub. No.: US 2025/0247635 A1
(43) Pub. Date: Jul. 31, 2025

(54) METHOD AND DEVICE FOR IMPLEMENTING HIGH-DYNAMIC RANGE IMAGING, AND IMAGE PROCESSING SYSTEM

(71) Applicant: GALAXYCORE SHANGHAI LIMITED CORPORATION, Shanghai (CN)

(72) Inventors: Jingxuan QIAO, Shanghai (CN); Jingwei WEI, Shanghai (CN)

(73) Assignee: GALAXYCORE SHANGHAI LIMITED CORPORATION, Shanghai (CN)

(21) Appl. No.: 18/864,408

(22) PCT Filed: Oct. 9, 2022
(86) PCT No.: PCT/CN2022/123969

§ 371 Date: Nov. 8, 2024

(30) Foreign Application Priority Data
Dec. 31, 2021 (CN) 202111657558.3

(51) Int. Cl. H04N 25/57; H04N 25/77; H04N 25/78

(52) U.S. Cl. CPC H04N 25/57; H04N 25/77; H04N 25/78

(57) ABSTRACT

A method and device for implementing high-dynamic range imaging, and an image processing system are provided. The device includes: an image sensor, a pixel array in the image sensor including a plurality of pixel units; and a column processing unit, including a gain control unit and an analog-to-digital conversion unit; where each pixel unit includes two photoelectric conversion units with different photosensitivity; and the gain control unit is configured to determine a brightness range of an image based on a signal voltage output by each pixel unit, and select the photoelectric conversion unit for signal conversion in each pixel unit, a charge-to-voltage conversion gain of each pixel unit and a voltage gain of the column processing unit based on the brightness range. With the method, device and system, the signal voltage allows to be read out only once, thereby shortening row readout time and increasing a frame rate.

### CROSS-REFERENCE TO RELATED APPLICATIONS

The present application is a National Stage Application of PCT International Application No.: PCT/CN2022/123969 filed on Oct. 9, 2022, which claims priority to Chinese Patent Application 202111657558.3, filed in the China National Intellectual Property Administration on Dec. 31, 2021, the disclosure of which is incorporated herein by reference in its entirety.

### TECHNICAL FIELD

The present disclosure generally relates to image sensor technology field, and more particularly, to a method and device for implementing High Dynamic Range (HDR) imaging, and an image processing system.

### BACKGROUND

HDR images can provide more dynamic range and image details than ordinary images. Low Dynamic Range (LDR) images with the best details corresponding to different exposure times are synthesized to generate a HDR image which can better reflect visual effects in a real environment.

Complementary Metal Oxide Semiconductor (CMOS) Image Sensors (CIS) are widely used in various fields, such as mobile phones, surveillance and security, machine vision, and consumer electronics. The expansion of application fields has put forward higher requirements on performance indicators of CIS. Dynamic range is one of essential indicators of CIS, which is particularly critical in relatively complex application scenarios, such as surveillance and security, and autonomous driving.

There are many ways to implement a HDR CIS. For example, a HDR image can be acquired by fusing multiple images with different exposure times, or be achieved by including two photodiodes with different photosensitivity in one pixel. The technology using such a pixel structure is called Dual Conversion Gain (DCG) pixel structure or Split Photodiode Pixel (SPP) structure.

In recent years, dual photodiode has received some attention and application in HDR CIS design, and a DCG+dual photodiode structure has been derived therefrom. However, an entire readout cycle is long, and a readout speed is low.

For example, in existing solutions, a triple-capture HDR CMOS image sensor combines split diode pixel technology with DCG readout to achieve HDR and LED Flicker Mitigation (LFM). Specific pixel circuit and readout timing of the triple-capture HDR CMOS image sensor are illustrated in FIG. 1 and FIG. 2, respectively.

The pixel includes a photodiode LPD with greater photosensitivity, a photodiode SPD with less photosensitivity, a transfer gate TXL of the LPD, a transfer gate TXS of the SPD, a floating diffusion gate DFD, a reset transistor RST, a pixel source follower transistor SF and a selection transistor RS.

A floating diffusion node FD of the photodiode LPD and the photodiode SPD is separated into FD1 and FD2 by the DFD transistor. A low conversion gain is obtained by using the floating diffusion gate DFD between FD1 and FD2 to increase gate equivalent capacitance C of the pixel source follower transistor SF. A high conversion gain CG is obtained by turning off the DFD. A charge of the photodiode LPD with greater photosensitivity can be sensed in both a low conversion gain mode LCG and a high conversion gain mode HCG, while the photodiode SPD with less photosensitivity can only be read out in the LCG mode.

Therefore, the sensor can obtain three sensing values, including HCG obtained by exposing the photodiode LPD with greater photosensitivity to the high conversion gain, LCG obtained by exposing the photodiode LPD with greater photosensitivity to the low conversion gain, and SPD obtained by exposing the photodiode SPD with less photosensitivity to the low conversion gain.

The three sensing values HCG, LCG and SPD are read out using a digital correlated double sampling circuit and then digitally combined to form a linear output pixel value.

Another pixel structure and working timing of a HDR image sensor in the existing solutions are illustrated in FIG. 3 and FIG. 4, respectively. FIG. 3 illustrates a simplified principle diagram of a pixel of a HDR image sensor. The pixel uses a large photodiode SP1, a small photodiode SP2, an in-pixel floating capacitor FC and seven transistors. Sensitivity of SP2 is less than that of SP1. The seven transistors are a transfer gate TGL of SP1, a transfer gate TGS of SP2, a floating diffusion gate FDG, a floating capacitor gate FCG, a reset transistor RST, a selection transistor SEL, and a source follower amplifier AMP. FDG and FCG separate a floating diffusion node FD into FD1, FD2 and FD3, and serve as switches connecting FD1, FD2 and FD3. Two electrodes of FC are respectively connected to FD3 and a counter electrode whose power supply voltage VDD is FC VDD.

The simplified timing diagram is shown in FIG. 4. Charge accumulated in SP1 is converted into two modes, including high conversion gain mode (SP1H) and low conversion gain mode (SP1L) through the FDG switch. Charge accumulated in SP2 is read out as SP2H. The charge is accumulated and combined with SP2 to be read out as SP2L. In this manner, four signals can be read out in one exposure. A signal with a highest signal-to-noise ratio is selected for each pixel, and the selected signals are then synthesized to generate one image.

From above, in the first existing solution, HDR is implemented by combining multiple groups of readout data together to generate a HDR image. Under this structure, in order to realize HDR, at least 3 groups of signals and resets, 6 data in total, need to be read out.

In the second existing solution, 4 groups of signals and resets, 8 data in total, need to be read out.

It can be seen that in order to realize a HDR image in the existing techniques, a large amount of data needs to be read and a read cycle is long.

### SUMMARY

Embodiments of the present disclosure provide a novel method for implementing a HDR image sensor, which shortens a readout cycle, and realizes a CMOS image sensor with a HDR.

An embodiment of the present disclosure provides a method for implementing HDR imaging, which is implemented based on an image sensor, wherein each pixel unit of the image sensor has a plurality of available charge-to-voltage conversion gain levels, each column signal processing unit of the image sensor has a plurality of available voltage gain levels, and each pixel unit includes two photoelectric conversion units with different photosensitivity; wherein the method includes: emptying photoelectric conversion units of pixel units in a current row; integrating photogenerated carriers on each of the photoelectric conversion units in the current row; resetting floating diffusion areas of the pixel units in the current row; setting the available charge-to-voltage conversion gain levels of the pixel units in the current row; setting the available voltage gain levels of the column signal processing units of the image sensor; converting and saving a conversion reference value of a reference voltage in a certain level setting state after the floating diffusion areas are reset, or multiple conversion reference values of the reference voltage in multiple level setting states after the floating diffusion areas are reset; controlling transfer transistors of the pixel units of the current row to transfer all or part of the photogenerated carriers of the pixel units from the photoelectric conversion units with higher photosensitivity to the floating diffusion areas; each of the column signal processing units detecting a signal voltage of the floating diffusion area of the pixel unit corresponding to the column, and accordingly selecting the photoelectric conversion unit for signal conversion in the pixel unit corresponding to the column; each of the column signal processing units detecting the signal voltage of the floating diffusion area of the pixel unit corresponding to the column, and accordingly determining a charge-to-voltage conversion gain level of the pixel unit corresponding to the column based on the plurality of available charge-to-voltage conversion gain levels; each of the column signal processing units detecting the signal voltage of the floating diffusion area of the pixel unit corresponding to the column, and accordingly determining a voltage gain level of the column signal processing unit based on the plurality of available voltage gain levels; the column signal processing units simultaneously converting the signal voltages of the floating diffusion areas of the pixel units to acquire a conversion signal value of the current row; and processing the conversion signal value and the one conversion reference value or multiple conversion reference values to acquire an image signal value of each pixel unit in the current row at corresponding charge-to-voltage conversion gain levels.

Optionally, a brightness range of an image is determined based on a signal voltage output by the pixel units.

Optionally, the photoelectric conversion unit for signal conversion in the pixel unit, the charge-to-voltage conversion gain of the pixel unit and the voltage gain of the column processing unit are adjusted based on the brightness range.

Optionally, different column signal processing units in the current row have different voltage gain levels.

Optionally, a gain level voltage is provided to be compared with an output signal voltage of the pixel unit once or multiple times to determine a brightness range of an image.

Optionally, based on the brightness range of the image, a control signal for selecting the photoelectric conversion unit in the pixel unit, determining the charge-to-voltage conversion gain and determining the voltage gain of the column processing unit is generated.

Optionally, different pixel units in the current row have different charge-to-voltage conversion gain levels.

Optionally, different pixel units in the current row select the photoelectric conversion units with different photosensitivity to perform signal conversion.

Optionally, said each of the column signal processing units detecting the signal voltage of the floating diffusion area of the pixel unit corresponding to the column, and accordingly selecting the photoelectric conversion unit for signal conversion in the pixel unit corresponding to the column, accordingly determining the charge-to-voltage conversion gain level of the pixel unit corresponding to the column based on the plurality of available charge-to-voltage conversion gain levels, and accordingly determining the voltage gain level of the column signal processing unit based on the plurality of available voltage gain levels includes: setting a plurality of level combinations based on sensitivity of the photoelectric conversion units, the available voltage gain levels and the available charge-to-voltage conversion gain levels, wherein the plurality of level combinations correspond to different voltage ranges; and determining a voltage range of the detected signal voltage of the floating diffusion area, determining the level combination corresponding to the voltage range, selecting the photoelectric conversion unit for signal conversion, and determining the voltage gain level and the charge-to-voltage conversion gain level.

Optionally, said each of the column signal processing units detecting the signal voltage of the floating diffusion area of the pixel unit corresponding to the column, and accordingly selecting the photoelectric conversion unit for signal conversion in the pixel unit corresponding to the column, accordingly determining the charge-to-voltage conversion gain level of the pixel unit corresponding to the column based on the plurality of available charge-to-voltage conversion gain levels, and accordingly determining the voltage gain level of the column signal processing unit based on the plurality of available voltage gain levels includes: determining the voltage gain level of the column signal processing unit corresponding to the signal voltage based on the signal voltage of the floating diffusion area and a first preset voltage range; determining the charge-to-voltage conversion gain level of the pixel unit corresponding to the signal voltage based on the signal voltage of the floating diffusion area and a second preset voltage range; and determining the photoelectric conversion unit for performing signal conversion in the pixel unit corresponding to the signal voltage based on the signal voltage of the floating diffusion area and a third preset voltage range.

Optionally, an image signal is divided into a plurality of sub-segments based on the available voltage gain levels and the available charge-to-voltage conversion gain levels, and the column signal processing units perform signal quantization on corresponding sub-segments and output the image signal.

Optionally, the image signal in each of the plurality of sub-segments is processed in a preset manner, to make image curves fitted by the image signal in each sub-segment be capable of being connected end to end in sequence and output.

Optionally, an image signal output corresponding to beginning and end parts of each sub-segment changes linearly, and the image signal output corresponding to a remaining part of each sub-segment changes nonlinearly.

Optionally, for multiple sub-segments of the image signal, the beginning part of each sub-segment has the same gain as the ending part of the previous sub-segment, to make the image curves smoothly transition between adjacent sub-segments.

An embodiment of the present disclosure further provides a device for implementing HDR imaging, including an image sensor, wherein the HDR imaging device further includes: a pixel array in the image sensor, including a plurality of pixel units; and a column processing unit, including a gain control unit and an analog-to-digital conversion unit; wherein each of the pixel units includes two photoelectric conversion units with different photosensitivity; and the gain control unit is configured to determine a brightness range of an image based on a signal voltage output by each of the pixel units, and select the photoelectric conversion unit for signal conversion in each of the pixel units, a charge-to-voltage conversion gain of each of the pixel units and a voltage gain of the column processing unit based on the brightness range.

Optionally, the gain control unit includes: a gain level voltage providing unit, configured to provide a gain level voltage for one or more comparisons with an output signal voltage of each of the pixel units to determine the brightness range of the image; and a gain control signal generating unit, configured to generate a control signal for selecting the photoelectric conversion unit in each of the pixel units, setting the charge-to-voltage conversion gain, and setting the voltage gain of the column processing unit based on the brightness range of the image.

Optionally, each pixel unit further includes a floating diffusion area, and each photoelectric conversion unit includes a photoelectric conversion part and a transfer gate, wherein the transfer gate is configured to transfer charges in the photoelectric conversion part to the floating diffusion area.

Optionally, the photoelectric conversion unit includes a first photoelectric conversion unit and a second photoelectric conversion unit, a first switch unit is provided between the first photoelectric conversion unit and the second photoelectric conversion unit, and the first switch unit is configured to switch different photoelectric conversion units to connect to the column processing unit.

Optionally, photosensitivity of the first photoelectric conversion unit is higher than photosensitivity of the second photoelectric conversion unit.

An embodiment of the present disclosure further provides an image processing system, including: the above HDR imaging device; and a row drive unit; wherein the pixel units in a same row are connected to a same row control line, and the row drive unit drives and controls the pixel units through the row control line; the pixel units in a same column are connected to a same column signal line, and an output signal of the pixel units is output to the column processing unit via the column signal line; and the pixel units in the same column are connected to a same column control line, and the column processing unit drives and controls the pixel units through the column control line.

Optionally, the image processing system further includes a column storage unit, wherein the column processing unit saves an analog-to-digital result of the output signal of the pixel units into the column storage unit.

Embodiments of the present disclosure may provide following advantages.

Before performing analog-to-digital conversion on the signal voltage read out by each pixel, a pre-judgment is performed first to determine the brightness range based on a voltage range output by the pixel, and adaptively adjust the conversion gain of the pixel. This allows the signal voltage to be read out only once, thereby shortening row readout time and increasing a frame rate.

Further, in the embodiments of the present disclosure, with a dual photodiode structure, adaptive conversion gain control can be adopted for signal paths of the two photoelectric conversion units respectively, and only two signal voltages are read out to realize pixel signal readout control for four brightness ranges.

Further, in the embodiments of the present disclosure, a floating charge conduction transistor and a floating charge storage capacitor introduced in the floating diffusion area of the second photoelectric conversion unit with lower photosensitivity can enable accumulation of overflow charges during an exposure process of the floating diffusion area of the second photoelectric conversion unit with lower photosensitivity under extremely high brightness, thereby further improving a dynamic range of imaging.

Further, the embodiments of the present disclosure may avoid a situation in the exiting techniques where four signal voltages need to be read out to realize pixel signal readout for four brightness ranges based on a dual photodiode structure, reduce a demand for data processing and storage, and save chip resources and power consumption.

### BRIEF DESCRIPTION OF THE DRAWINGS

FIG. 1 is a circuit diagram of a pixel structure in a HDR CMOS image sensor in the existing techniques;

FIG. 2 is a readout timing diagram of the pixel structure in the HDR CMOS image sensor shown in FIG. 1;

FIG. 3 is a circuit diagram of a pixel structure in another HDR image sensor in the existing techniques;

FIG. 4 is a readout timing diagram of the pixel structure in the HDR image sensor shown in FIG. 3;

FIG. 5 is a flow chart of a method for implementing a HDR image sensor according to an embodiment of the present disclosure;

FIG. 6 is a structural block diagram of a HDR imaging device according to an embodiment of the present disclosure;

FIG. 7 is a circuit diagram of a pixel structure in a HDR image sensor according to an embodiment of the present disclosure;

FIG. 8 is a readout timing diagram of the pixel structure shown in FIG. 7;

FIG. 9 is a circuit diagram of a pixel structure in a HDR image sensor according to an embodiment of the present disclosure;

FIG. 10 is an image processing system according to an embodiment of the present disclosure; and

FIG. 11 is an image processing system according to an embodiment of the present disclosure.

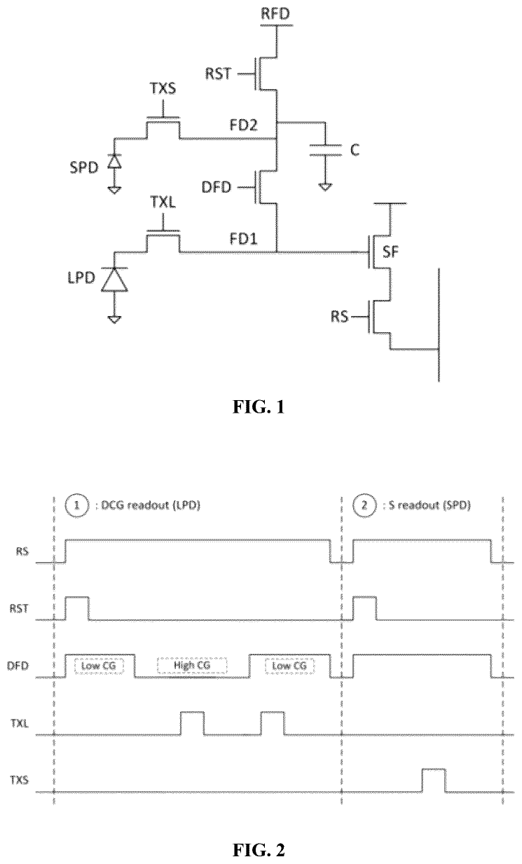

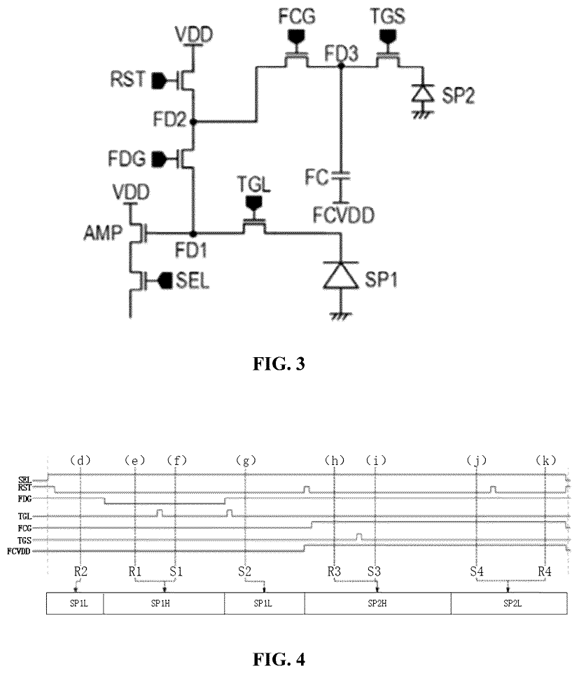

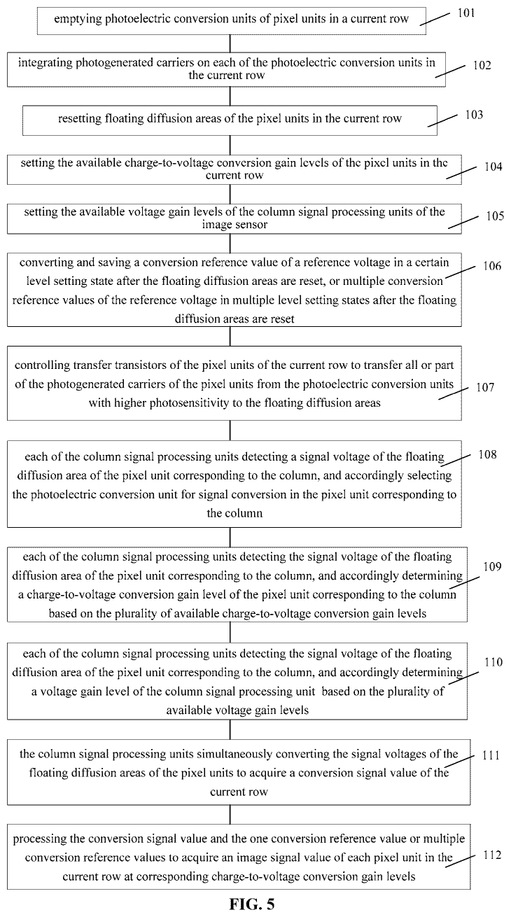

### DETAILED DESCRIPTION

Technical solutions provided by the present disclosure aim to propose a new method for implementing a HDR CIS based on a combination of a method for adaptively controlling DCG and a dual photodiode structure.

Many specific details are described in following descriptions to facilitate a full understanding of the present disclosure. However, the present disclosure can be implemented in many other ways than those described herein. Those skilled in the art can make similar generalizations without violating the connotation of the present disclosure, thus the present disclosure is not limited to the specific implementation disclosed below.

The present disclosure is described in detail using schematic diagrams. In the detailed descriptions of embodiments of the present disclosure, for the convenience of explanation, the schematic diagrams are only examples and should not limit the scope of the present disclosure.

In order to make the above-mentioned objects, features and advantages of the present disclosure more obvious and easier to understand, specific embodiments of the present disclosure are described in detail below in conjunction with accompanying drawings.

FIG. 5 is a flow chart of a method for implementing a HDR image sensor according to an embodiment of the present disclosure. Each pixel unit of the image sensor has a plurality of available charge-to-voltage conversion gain levels, each column signal processing unit of the image sensor has a plurality of available voltage gain levels, and each pixel unit includes two photoelectric conversion units with different photosensitivity.

The method includes: S101, emptying photoelectric conversion units of pixel units in a current row; S102, integrating photogenerated carriers on each of the photoelectric conversion units in the current row; S103, resetting floating diffusion areas of the pixel units in the current row; S104, setting the available charge-to-voltage conversion gain levels of the pixel units in the current row; S105, setting the available voltage gain levels of the column signal processing units of the image sensor; S106, converting and saving a conversion reference value of a reference voltage in a certain level setting state after the floating diffusion areas are reset, or multiple conversion reference values of the reference voltage in multiple level setting states after the floating diffusion areas are reset; S107, controlling transfer transistors of the pixel units of the current row to transfer all or part of the photogenerated carriers of the pixel units from the photoelectric conversion units with higher photosensitivity to the floating diffusion areas; S108, each of the column signal processing units detecting a signal voltage of the floating diffusion area of the pixel unit corresponding to the column, and accordingly selecting the photoelectric conversion unit for signal conversion in the pixel unit corresponding to the column; S109, each of the column signal processing units detecting the signal voltage of the floating diffusion area of the pixel unit corresponding to the column, and accordingly determining a charge-to-voltage conversion gain level of the pixel unit corresponding to the column based on the plurality of available charge-to-voltage conversion gain levels; S110, each of the column signal processing units detecting the signal voltage of the floating diffusion area of the pixel unit corresponding to the column, and accordingly determining a voltage gain level of the column signal processing unit based on the plurality of available voltage gain levels; S111, the column signal processing units simultaneously converting the signal voltages of the floating diffusion areas of the pixel units to acquire a conversion signal value of the current row; and S112, processing the conversion signal value and the one conversion reference value or multiple conversion reference values to acquire an image signal value of each pixel unit in the current row at corresponding charge-to-voltage conversion gain levels.

Further, in the above steps, different column signal processing units of the current row may have different voltage gain levels, different pixel units of the current row may have different charge-to-voltage conversion gain levels, and different pixel units of the current row may select photoelectric conversion units with different photosensitivity for signal conversion.

Optionally, said each of the column signal processing units detecting the signal voltage of the floating diffusion area of the pixel unit corresponding to the column, and accordingly selecting the photoelectric conversion unit for signal conversion in the pixel unit corresponding to the column, accordingly determining the charge-to-voltage conversion gain level of the pixel unit corresponding to the column based on the plurality of available charge-to-voltage conversion gain levels, and accordingly determining the voltage gain level of the column signal processing unit based on the plurality of available voltage gain levels includes: setting a plurality of level combinations based on sensitivity of the photoelectric conversion units, the available voltage gain levels and the available charge-to-voltage conversion gain levels, wherein the plurality of level combinations correspond to different voltage ranges; and determining a voltage range of the detected signal voltage of the floating diffusion area, determining the level combination corresponding to the voltage range, selecting the photoelectric conversion unit for signal conversion, and determining the voltage gain level and the charge-to-voltage conversion gain level.

Optionally, said each of the column signal processing units detecting the signal voltage of the floating diffusion area of the pixel unit corresponding to the column, and accordingly selecting the photoelectric conversion unit for signal conversion in the pixel unit corresponding to the column, accordingly determining the charge-to-voltage conversion gain level of the pixel unit corresponding to the column based on the plurality of available charge-to-voltage conversion gain levels, and accordingly determining the voltage gain level of the column signal processing unit based on the plurality of available voltage gain levels includes: determining the voltage gain level of the column signal processing unit corresponding to the signal voltage based on the signal voltage of the floating diffusion area and a first preset voltage range; determining the charge-to-voltage conversion gain level of the pixel unit corresponding to the signal voltage based on the signal voltage of the floating diffusion area and a second preset voltage range; and determining the photoelectric conversion unit for performing signal conversion in the pixel unit corresponding to the signal voltage based on the signal voltage of the floating diffusion area and a third preset voltage range.

Optionally, an image signal is divided into a plurality of sub-segments based on the available voltage gain levels and the available charge-to-voltage conversion gain levels, and the column signal processing units perform signal quantization on corresponding sub-segments and output the image signal.

Optionally, the image signal in each of the plurality of sub-segments is processed in a preset manner, to make image curves fitted by the image signal in each sub-segment be capable of being connected end to end in sequence and output.

Optionally, an image signal output corresponding to beginning and end parts of each sub-segment changes linearly, and the image signal output corresponding to a remaining part of each sub-segment changes nonlinearly.

Optionally, for multiple sub-segments of the image signal, the beginning part of each sub-segment has the same gain as the ending part of the previous sub-segment, to make the image curves smoothly transition between adjacent sub-segments.

FIG. 6 is a structural block diagram of a HDR imaging device according to an embodiment of the present disclosure. The HDR imaging device includes an image sensor. Specifically, the HDR imaging device further includes: a pixel array in the image sensor, including a plurality of pixel units 40; and a column processing unit, including a gain control unit 70 and an analog-to-digital conversion unit 80.

Each of the pixel units 40 includes two photoelectric conversion units with different photosensitivity.

The gain control unit 70 is configured to determine a brightness range of an image based on a signal voltage output by each of the pixel units, and select the photoelectric conversion units for signal conversion in each of the pixel units, a charge-to-voltage conversion gain of each of the pixel units and a voltage gain of the column processing unit based on the brightness range.

Specifically, the gain control unit 70 includes: a gain level voltage providing unit, configured to provide a gain level voltage for one or more comparisons with an output signal voltage of each of the pixel units to determine the brightness range of the image; and a gain control signal generating unit, configured to generate a control signal for selecting the photoelectric conversion unit in each of the pixel units, setting the charge-to-voltage conversion gain, and setting the voltage gain of the column processing unit based on the brightness range of the image.

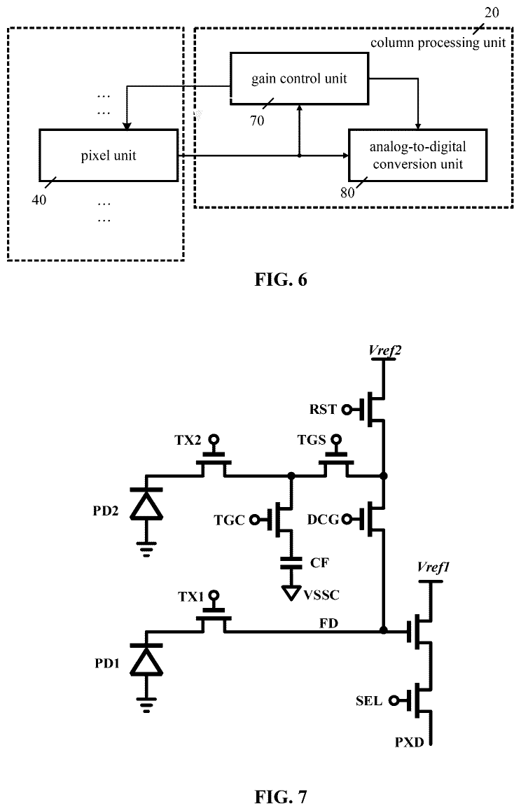

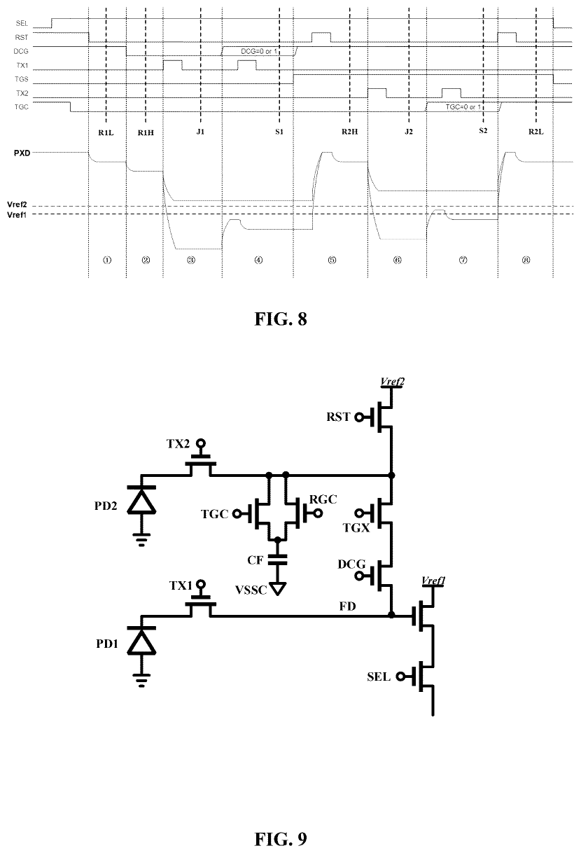

Referring to FIGS. 6 to 9, FIG. 7 is a circuit diagram of a pixel structure in a HDR image sensor according to an embodiment of the present disclosure, FIG. 8 is a readout timing diagram of the pixel structure shown in FIG. 7, and FIG. 9 is a circuit diagram of a pixel structure in a HDR image sensor according to another embodiment of the present disclosure.

In the pixel structure as shown in FIG. 7 or 9, the photoelectric conversion unit includes a first photoelectric conversion unit PD1 and a second photoelectric conversion unit PD2 with different photosensitivity. In some embodiments, photosensitivity of the first photoelectric conversion unit PD1 is higher than photosensitivity of the second photoelectric conversion unit PD2.

In some embodiments, each photoelectric conversion unit includes a photoelectric conversion part and a transfer gate, and the pixel unit further includes a floating diffusion area FD, where the transfer gate is configured to transfer charges in the photoelectric conversion part to the floating diffusion area FD. In some embodiments, the transfer gate includes transfer transistors TXL and TXS.

In some embodiments, a first switch unit DCG is provided between the first photoelectric conversion unit and the second photoelectric conversion unit, and is configured to switch different photoelectric conversion units to connect to the column processing unit.

The photoelectric conversion unit and the floating diffusion area FD are arranged between a first reference voltage Vref1 and a second reference voltage Vref2, a first reference voltage selection transistor is arranged between the floating diffusion area FD and the first reference voltage Vref1, and a reset transistor RST is arranged between the floating diffusion area FD and the second reference voltage Vref2.

The first photoelectric conversion unit PD1 is connected to a gate of the first reference voltage selection transistor, a source and a drain of the first reference voltage selection transistor are respectively connected to the first reference voltage Vref1, and a column selection transistor SEL, and a gate of the column selection transistor SEL is connected to a column selection signal.

A floating charge storage area CF is provided at an end of the second photoelectric conversion unit PD2 toward the floating diffusion area FD, and an end of the floating charge storage area CF away from the second photoelectric conversion unit PD2 is connected to a power supply voltage VSSC. The floating charge storage area CF is configured to store electrons overflowed from the second photoelectric conversion unit PD2 during an exposure process, and provide different conversion gains when being accessed. In some embodiments, the floating charge storage area CF is a capacitor.

Based on a capacitance structure of the floating charge storage area CF, the power supply voltage VSSC may be a high level, a low level, or a varying waveform voltage.

A floating charge turn-on transistor TGC is further provided between the floating charge storage area and the second photoelectric conversion unit, and is configured to turn on the floating charge storage area CF when needed.

In some embodiments, the floating charge turn-on transistor TGC and the floating charge storage area (capacitor) CF introduced in the floating diffusion area FD of the second photoelectric conversion unit PD2 with lower photosensitivity can accumulate overflow charges during the exposure process of PD2 under extremely high brightness, thereby further improving a dynamic range.

Referring to FIG. 7, a second switch transistor TGS is disposed between the floating charge storage area (CF) and the floating diffusion area.

Referring to FIG. 9, a fourth switch unit RGC connected in parallel with the floating charge turn-on transistor TGC is further provided between the floating charge storage area and the second photoelectric conversion unit to control the access to the floating charge storage area during exposure time. A fifth switch unit TGX is further provided between the first switch unit DCG and the second photoelectric conversion unit.

In some embodiments, the first photoelectric conversion unit includes a first transmission gate TX1 and a first photoelectric conversion unit PD1.

The second photoelectric conversion unit includes a second transmission gate TX2 and a second photoelectric conversion unit PD2.

In the above embodiments, a reference voltage is provided in each of two pre-judgments, and an on/off state of DCG and TGC is determined according to results of the pre-judgments. Readout processes of PD1 and PD2 are relatively independent, and the signal voltage needs to be read out twice.

FIG. 8 is a readout timing diagram of the pixel structure shown in FIG. 7. Before a process of the readout timing shown in FIG. 8, the method further includes: emptying the photoelectric conversion units PD1 and PD2 of each of the pixel units in the current row; integrating photogenerated carriers on each of the photoelectric conversion units PD1 and PD2 in the current row; resetting the floating diffusion area FD of each pixel unit 40 in the current row; setting the available charge-to-voltage conversion gain levels of each pixel unit 40 in the current row; and setting the available voltage gain levels of the column signal processing unit of the image sensor.

Specifically, a detailed process of the readout timing shown in FIG. 8 is as follows:
1) setting DCG signal to high, DCG being turned on, and reading a FD node reference voltage R1L (Reference/PD1/Low CG);
2) setting the DCG signal to low, the DCG being turned off, and reading the FD node reference voltage R1H (Reference/PD1/High CG),
where a conversion reference value reference voltage R1L and a reference voltage R1H of the floating diffusion area in a specific level setting state are converted and saved through 1) and 2).
3) turning on the transfer transistor TX1 of each pixel unit in the current row, and electrons accumulated in PD1 being transferred to FD during the exposure process;
each column signal processing unit detecting the signal voltage FD node voltage of the floating diffusion area of the pixel unit corresponding to the column, performing the first pre-judgment, and accordingly determining the charge-to-voltage conversion gain level of the pixel unit corresponding to the column based on the available charge-to-voltage conversion gain levels, specifically,
where if PXD<Vref1, current brightness is determined to be high, and DCG=1 is set; otherwise, the current brightness is determined to be low, and DCG=0 is set;
4) according to the pre-judgment result of 3), each column signal processing unit simultaneously converting the signal voltage of the floating diffusion area of the corresponding pixel unit to acquire a conversion signal value of the current row, where specifically, DCG is controlled to be turned on or off, TX1 is turned on once, and then a signal voltage S1 (Signal/PD1) of the FD node is read;
5) keeping DCG and TGS in an on state, turning on RST momently, reading the FD node reference voltage R2H (Reference/PD2/High CG), turning on TX2, electrons accumulated in PD2 during the exposure process being transferred to FD, reading the FD node voltage, and performing the second pre-judgement, where if PXD<Vref2, it is at an extremely bright brightness, TGC=1 is set; otherwise, TGC=0 is set.
6) based on the pre-judgement result of 5), TGC being controlled to be turned on or off, TX2 being turned on once, and the signal voltage S2 (Signal/PD2) of the FD node being read;
7) keeping TGC in an on state, turning on RST momently, and reading the FD node reference voltage R2L (Reference/PD2/Low CG);
where Vref1 and Vref2 may be the same or different.

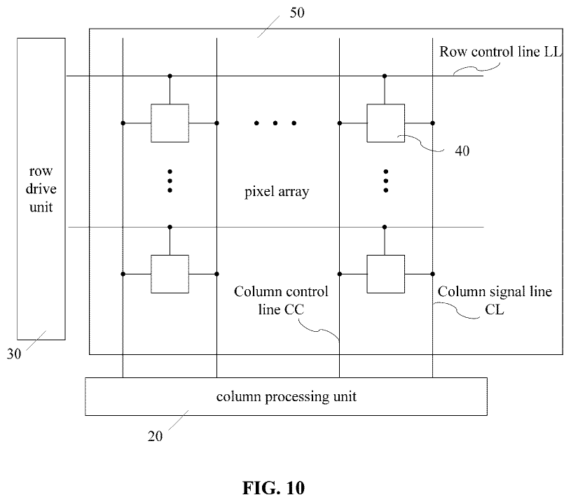

FIG. 10 is an image processing system according to an embodiment of the present disclosure. The image processing system includes: the above HDR imaging device 50; and a row drive unit 30.

The pixel units 40 in a same row are connected to a same row control line LL, and the row drive unit 30 drives and controls the pixel units 40 through the row control line LL. The pixel units 40 in a same column are connected to a same column signal line CL, and an output signal of the pixel units 40 is output to the column processing unit 20 via the column signal line CL. The pixel units 40 in the same column are connected to a same column control line CC, and the column processing unit drives and controls the pixel units 40 through the column control line CC.

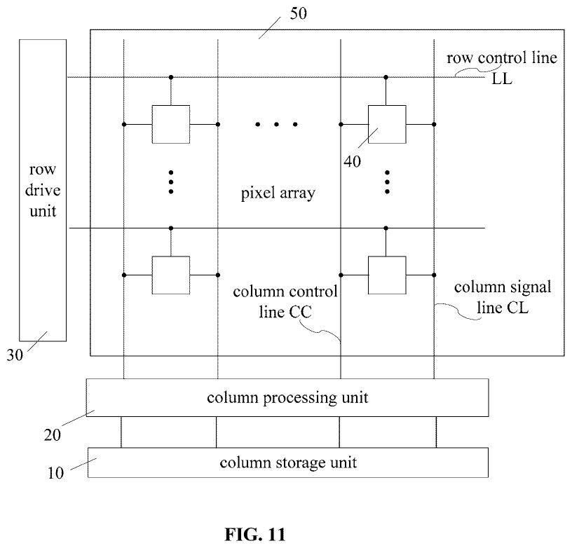

Further, referring to FIG. 11, an image processing system according to another embodiment of the present disclosure further includes a column storage unit 10, where the column processing unit 20 saves an analog-to-digital result of the output signal of the pixel units into the column storage unit 10.

In the image processing system provided by the embodiments of the present disclosure, after the column processing unit detecting the image brightness range, the gain control unit can switch the conversion gain of the pixel units on the basis of adjusting an analog gain of the output signal of the pixel units. Especially for the pixel structure with multiple photodiodes, selection of the photodiodes can be adaptively switched, thereby reducing the number and time of reading data, reducing a demand for data processing and storage, and improving a frame rate.

Although the present disclosure has been disclosed above with reference to preferred embodiments thereof, it should be understood that the disclosure is presented by way of example only, and not limitation. Those skilled in the art may make possible changes and modifications to the technical solutions of the present disclosure by using the methods and technical solutions disclosed above without departing from the spirit and scope of the present disclosure. Therefore, any simple modifications, equivalent changes and modifications made to the above embodiments based on the technical essence of the present disclosure without departing from the content of the technical solutions of the present disclosure shall fall within the scope of the technical solutions of the present disclosure.

1. A method for implementing High Dynamic Range (HDR) imaging, implemented based on an image sensor, wherein each pixel unit of the image sensor has a plurality of available charge-to-voltage conversion gain levels, each column signal processing unit of the image sensor has a plurality of available voltage gain levels, and each pixel unit comprises two photoelectric conversion units with different photosensitivity;
wherein the method comprises:
emptying photoelectric conversion units of pixel units in a current row;
integrating photogenerated carriers on each of the photoelectric conversion units in the current row;
resetting floating diffusion areas of the pixel units in the current row;
setting the available charge-to-voltage conversion gain levels of the pixel units in the current row;
setting the available voltage gain levels of the column signal processing units of the image sensor;
converting and saving a conversion reference value of a reference voltage in a certain level setting state after the floating diffusion areas are reset, or multiple conversion reference values of the reference voltage in multiple level setting states after the floating diffusion areas are reset;
controlling transfer transistors of the pixel units of the current row to transfer all or part of the photogenerated carriers of the pixel units from the photoelectric conversion units with higher photosensitivity to the floating diffusion areas;
each of the column signal processing units detecting a signal voltage of the floating diffusion area of the pixel unit corresponding to the column, and accordingly selecting the photoelectric conversion unit for signal conversion in the pixel unit corresponding to the column;
each of the column signal processing units detecting the signal voltage of the floating diffusion area of the pixel unit corresponding to the column, and accordingly determining a charge-to-voltage conversion gain level of the pixel unit corresponding to the column based on the plurality of available charge-to-voltage conversion gain levels;
each of the column signal processing units detecting the signal voltage of the floating diffusion area of the pixel unit corresponding to the column, and accordingly determining a voltage gain level of the column signal processing unit based on the plurality of available voltage gain levels;
the column signal processing units simultaneously converting the signal voltages of the floating diffusion areas of the pixel units to acquire a conversion signal value of the current row; and
processing the conversion signal value and the one conversion reference value or multiple conversion reference values to acquire an image signal value of each pixel unit in the current row at corresponding charge-to-voltage conversion gain levels.

2. The method according to claim 1, wherein a brightness range of an image is determined based on a signal voltage output by the pixel unit.

3. The method according to claim 2, where the photoelectric conversion unit for signal conversion in the pixel unit, the charge-to-voltage conversion gain of the pixel unit and the voltage gain of the column processing unit are adjusted based on the brightness range.

4. The method according to claim 1, wherein different column signal processing units in the current row have different voltage gain levels.

5. The method according to claim 4, wherein a gain level voltage is provided to be compared with an output signal voltage of the pixel unit once or multiple times to determine a brightness range of an image.

6. The method according to claim 5, wherein based on the brightness range of the image, a control signal for selecting the photoelectric conversion unit in the pixel unit, determining the charge-to-voltage conversion gain and determining the voltage gain of the column processing unit is generated.

7. The method according to claim 1, wherein different pixel units in the current row have different charge-to-voltage conversion gain levels.

8. The method according to claim 1, wherein different pixel units in the current row select the photoelectric conversion units with different photosensitivity to perform signal conversion.

9. The method according to claim 1, wherein said each of the column signal processing units detecting the signal voltage of the floating diffusion area of the pixel unit corresponding to the column, and accordingly selecting the photoelectric conversion unit for signal conversion in the pixel unit corresponding to the column, accordingly determining the charge-to-voltage conversion gain level of the pixel unit corresponding to the column based on the plurality of available charge-to-voltage conversion gain levels, and accordingly determining the voltage gain level of the column signal processing unit based on the plurality of available voltage gain levels comprises:
setting a plurality of level combinations based on sensitivity of the photoelectric conversion units, the available voltage gain levels and the available charge-to-voltage conversion gain levels, wherein the plurality of level combinations correspond to different voltage ranges; and
determining a voltage range of the detected signal voltage of the floating diffusion area, determining the level combination corresponding to the voltage range, selecting the photoelectric conversion unit for signal conversion, and determining the voltage gain level and the charge-to-voltage conversion gain level.

10. The method according to claim 1, wherein said each of the column signal processing units detecting the signal voltage of the floating diffusion area of the pixel unit corresponding to the column, and accordingly selecting the photoelectric conversion unit for signal conversion in the pixel unit corresponding to the column, accordingly determining the charge-to-voltage conversion gain level of the pixel unit corresponding to the column based on the plurality of available charge-to-voltage conversion gain levels, and accordingly determining the voltage gain level of the column signal processing unit based on the plurality of available voltage gain levels comprises:
determining the voltage gain level of the column signal processing unit corresponding to the signal voltage based on the signal voltage of the floating diffusion area and a first preset voltage range;
determining the charge-to-voltage conversion gain level of the pixel unit corresponding to the signal voltage based on the signal voltage of the floating diffusion area and a second preset voltage range; and
determining the photoelectric conversion unit for performing signal conversion in the pixel unit corresponding to the signal voltage based on the signal voltage of the floating diffusion area and a third preset voltage range.

11. The method according to claim 1, wherein an image signal is divided into a plurality of sub-segments based on the available voltage gain levels and the available charge-to-voltage conversion gain levels, and the column signal processing units perform signal quantization on corresponding sub-segments and output the image signal.

12. The method according to claim 11, wherein the image signal in each of the plurality of sub-segments is processed in a preset manner, to make image curves fitted by the image signal in each sub-segment be capable of being connected end to end in sequence and output.

13. The method according to claim 11, wherein an image signal output corresponding to beginning and end parts of each sub-segment changes linearly, and the image signal output corresponding to a remaining part of each sub-segment changes nonlinearly.

14. The method according to claim 13, wherein for multiple sub-segments of the image signal, the beginning part of each sub-segment has the same gain as the ending part of the previous sub-segment, to make the image curves smoothly transition between adjacent sub-segments.

15. A High Dynamic Range (HDR) imaging device, comprising an image sensor, wherein the HDR imaging device further comprises:
a pixel array in the image sensor, comprising a plurality of pixel units; and
a column processing unit, comprising a gain control unit and an analog-to-digital conversion unit;
wherein each of the pixel units comprises two photoelectric conversion units with different photosensitivity; and
the gain control unit is configured to determine a brightness range of an image based on a signal voltage output by each of the pixel units, and select the photoelectric conversion unit for signal conversion in each of the pixel units, a charge-to-voltage conversion gain of each of the pixel units and a voltage gain of the column processing unit based on the brightness range.

16. The HDR imaging device according to claim 15, wherein the gain control unit comprises:
a gain level voltage providing unit, configured to provide a gain level voltage for one or more comparisons with an output signal voltage of each of the pixel units to determine the brightness range of the image; and
a gain control signal generating unit, configured to generate a control signal for selecting the photoelectric conversion unit in each of the pixel units, setting the charge-to-voltage conversion gain, and setting the voltage gain of the column processing unit based on the brightness range of the image.

17. The HDR imaging device according to claim 15, wherein each pixel unit further comprises a floating diffusion area, and each photoelectric conversion unit comprises a photoelectric conversion part and a transfer gate, wherein the transfer gate is configured to transfer charges in the photoelectric conversion part to the floating diffusion area.

18. The HDR imaging device according to claim 15, wherein the photoelectric conversion unit comprises a first photoelectric conversion unit and a second photoelectric conversion unit, a first switch unit is provided between the first photoelectric conversion unit and the second photoelectric conversion unit, the first switch unit is configured to switch different photoelectric conversion units to connect to the column processing unit, and photosensitivity of the first photoelectric conversion unit is higher than photosensitivity of the second photoelectric conversion unit.

19. (canceled)

20. An image processing system, comprising:
the High Dynamic Range (HDR) imaging device of claim 15; and
a row drive unit;
wherein the pixel units in a same row are connected to a same row control line, and the row drive unit drives and controls the pixel units through the row control line;
the pixel units in a same column are connected to a same column signal line, and an output signal of the pixel units is output to the column processing unit via the column signal line; and
the pixel units in the same column are connected to a same column control line, and the column processing unit drives and controls the pixel units through the column control line.

21. The image processing system according to claim 20, further comprising a column storage unit, wherein the column processing unit saves an analog-to-digital result of the output signal of the pixel units into the column storage unit.
